(19) United States
(12) Patent Application Publication
(10) Pub. No.: US 2013/0037125 A1
(43) Pub. Date: Feb. 14, 2013

(54) PRESSURE RELIEF VALVE ASSEMBLY

(71) Applicants: Philip Drake, North Richland Hills, TX (US); Brian Witkowski, Weatherford, TX (US)

(72) Inventors: Philip Drake, North Richland Hills, TX (US); Brian Witkowski, Weatherford, TX (US)

(73) Assignee: S.P.M. Flow Control, Inc., Fort Worth, TX (US)

(21) Appl. No.: 13/572,293

(22) Filed: Aug. 10, 2012

Related U.S. Application Data
(60) Provisional application No. 61/522,234, filed on Aug. 10, 2011.

(51) Int. Cl. F16K 17/14; F17D 5/00; F16K 51/00

(52) U.S. Cl. 137/68.23; 137/550; 137/14; 137/15.19

(57) ABSTRACT

A pressure relief valve assembly includes a body having a passage extending therethrough. The body includes an upstream end adapted to be connected to a source of fluid pressure, an intermediate portion, and a downstream end having a downstream exit. A rupture disk is mounted in the passageway and blocks the fluid pressure of the source from the downstream end. In operation, the rupture disk configured to rupture above a predetermined differential fluid pressure. A catcher is disposed in the passage downstream of the rupture disk. The catcher generally includes a disk portion with at least one opening sized to prevent passage of the rupture disk through the catcher in response to a rupture disk failure while simultaneously allowing fluid flow through the catcher to the downstream exit.

### CROSS-REFERENCE TO RELATED APPLICATIONS

This application claims priority to U.S. Provisional Patent Application Ser. No. 61/522,234, filed on Aug. 10, 2011, which is incorporated herein by reference in its entirety.

### TECHNICAL FIELD

This disclosure relates in general to valves, and in particular, to a pressure relief valve assembly that relieves a pressure of a pumping system, and even more particularly, to a catcher member for use in a pressure relief valve assembly operable to prevent the passage of the rupture disk to downstream portions of the pressure relief valve assembly.

### BACKGROUND OF THE DISCLOSURE

Large high pressure pumping systems are commonly used in mining and oilfield applications. For example, high pressure pumping systems are oftentimes used for hydraulic fracturing operations, re-circulating drilling mud within pumping systems, and even “killing” a well. During a “well kill”, for example, drilling mud is pumped at high pressures, oftentimes as much as 30,000 psi, into a wellbore to suppress the pressure of the formation fluid. In the event of an overpressure of the pumping system (i.e., the operating pressure increases above a predetermined level), a pressure relief valve vents the system. One particular method includes using a pressure relief valve incorporating a rupture disk. For example, a rupture disk is oftentimes placed in a relief valve body to prevent the flow of fluid through the body until the fluid pressure reaches a predetermined value. In response to an overpressure condition of the system (e.g., the pressure reaching approximately 30,000 psi), the rupture disk will sever to facilitate and/or otherwise open a fluid pathway through the valve body. As such, fluid is directed through the pathway, which enables the venting of the excess pressure, either to a holding tank, the environment, or otherwise. However, such configurations can produce an obstruction or cause damage to equipment downstream of the rupture disk. In some cases, the blown rupture disk presents a safety issue, since the rupture disk can project from the relief valve body at dangerously high velocities potentially injuring bystanders.

### SUMMARY

In a first aspect, a pressure relief valve assembly is provided that includes a body having a passage extending therethrough, the body having an upstream end adapted to be connected to a source of fluid pressure, an intermediate portion, and a downstream end having a downstream exit. A rupture disk is mounted in the passage and blocks the fluid pressure of the source from the downstream end. The rupture disk is configured to rupture above a predetermined differential fluid pressure. A catcher is disposed in the passage downstream of the rupture disk, the catcher includes a disk portion with at least one opening sized to prevent passage of the rupture disk through the catcher in response to a rupture disk failure while simultaneously allowing fluid flow through the catcher to the downstream exit to thereby prevent an overpressure condition while reducing the likelihood of damage to the valve assembly.

In certain embodiments, at least a portion of the passage between the catcher and the rupture disk is larger in diameter than the diameter of the passage upstream of the rupture disk.

In other certain embodiments, the passage between the catcher and the rupture disk has a smaller bore section having a diameter and a larger bore section having a diameter larger than the diameter of the smaller bore section, the larger bore section proximate to the catcher and the smaller bore section proximate to the rupture disk.

In yet another embodiment, the disk portion includes an upstream surface and a downstream surface and the at least one opening extending through the disk portion between the upstream surface and the downstream surface.

In still another embodiment, the at least one opening comprises a plurality of spaced apart openings.

In yet another embodiment, the at least one opening extends substantially across the disk portion.

In other embodiments, the disk portion comprises a diameter substantially equal to the diameter of the body passage in the intermediate portion.

In still another embodiment, the catcher comprises an outer ring coaxially supporting the disk portion, the outer ring adapted to secure the catcher to the body.

In still another embodiment, the rupture disk includes a mounting member having a bore and a shearable element disposed within the bore and coupled to the mounting member. The shearable element includes a circumferential groove, wherein the shearable element is adapted to detach from the mounting member along the circumferential groove at the predetermined differential fluid pressure.

In yet another embodiment, a diameter of the circumferential groove is less than a diameter of a portion of the passage between the catcher and the mounting member.

In still yet another embodiment, the body includes a connecting member having a downstream end, an intermediate member having an upstream end that abuts and is coupleable to the downstream end of the connecting member, and an annular pocket formed at the abutting portions of the intermediate member and the connecting member for receiving the rupture disk therein. The intermediate member is detachable from connecting member to facilitate access to the annular pocket and the rupture disk.

In another embodiment, the body includes a connecting member having an upstream end connected to the source of fluid pressure and a downstream end, an intermediate member having an upstream end that abuts and is coupleable to the downstream end of the connecting member, and an end member having an upstream end wherein the upstream end of the end member secures to the downstream end of the intermediate member, the catcher being disposed therebetween.

In still another embodiment, the connection between the downstream end of the connecting member and the upstream end of the intermediate member has a first internal fluid pressure rating. The connection between the downstream end of the intermediate member and the upstream end of the end member having a second and lesser internal fluid pressure rating than the first fluid pressure rating.

In a second aspect, a catcher for a pressure relief valve assembly is provided. The pressure relief valve assembly includes a body with a passage extending therethrough, the body having an upstream end adapted to be connected to a source of fluid pressure, and a downstream end having a downstream exit, a rupture disk mounted in the passage and blocking the fluid pressure of the source from the downstream end, the rupture disk configured to rupture above a predetermined differential fluid pressure. The catcher comprises a disk portion having an upstream surface and a downstream surface, at least one opening extending through the disk portion between the upstream surface and the downstream surface. The disk portion is mountable downstream of the rupture disk and wherein the at the least one opening is sized to prevent passage of the rupture disk to the downstream exit in response to a rupture disk failure while simultaneously allowing fluid flow through the catcher to the downstream exit to thereby prevent an overpressure condition while reducing the likelihood of damage to the valve assembly.

In certain embodiments, the at least one opening comprises a plurality of openings.

In other certain embodiments, the last least one opening extends substantially across the disk portion.

In another embodiment, the disk portion comprises a diameter substantially equal to the diameter of the body passage.

In yet another embodiment, the catcher includes an outer ring coaxially supporting the disk portion, the outer ring adapted to secure the catcher to the body.

In a third aspect, a pressure relief valve assembly is provided including a connecting member having an upstream end and a downstream end, an intermediate member having an upstream end that abuts and connects to the downstream end of the connecting member and an end member having an upstream end that connects to the downstream end of the intermediate member. A passage extends from the upstream end of the connection member through the intermediate member and through the downstream end of the end member. The assembly also includes a rupture disk disposed within the passage, the rupture disk configured to block fluid pressure in the portion of the passage in the connecting member from the portion of the passage in the intermediate member, the rupture disk adapted to rupture in response to a predetermined differential fluid pressure. The assembly also includes a catcher mounted in the passage for blocking portions of the rupture disk to prevent the rupture disk traveling downstream in the event the rupture disk ruptures, the catcher having at least one opening therethrough for enabling fluid to flow into the end member while simultaneously blocking portions of the rupture disk from traveling into the end member.

In certain embodiments, the assembly also includes flanges on the downstream end of the connecting member and on the upstream end of the intermediate member for securing the connecting member and the intermediate member together.

In other certain embodiments, the assembly includes flanges on the downstream end of the intermediate member and on the upstream end of the end member and wherein the catcher is sandwiched between the flanges on the downstream end of the intermediate member and on the upstream end of the end member.

In yet another embodiment, the rupture disk includes a mounting member having a bore therethrough with a diameter no larger than a diameter of the passage in the intermediate member and a shearable element disposed within the bore and coupled to the mounting member. The shearable element includes a circumferential groove and is adapted to shear from the mounting member at the circumferential groove in response to the predetermined differential fluid pressure.

In still another embodiment, a downstream portion of the passage within the intermediate member has a larger diameter than an upstream portion of the passage within the intermediate member.

In other certain embodiments, the catcher includes a disk portion having an upstream surface and a downstream surface. The at least one opening extends through the disk portion between the upstream surface and the downstream surface.

In other embodiments, the at least one opening includes a plurality of spaced apart openings.

In yet other embodiments, the at least one opening extends substantially across the disk portion.

In another embodiment, the catcher includes an outer ring coaxially supporting a disk portion. The outer ring is adapted to secure the catcher between the intermediate member and the end member.

In a fourth aspect, there is provided a method of relieving pressure including providing a relief valve having a body with a passage extending therethrough, providing a rupture disk mounted in the passage and providing a catcher in the passage downstream of the rupture disk, the catcher having a disk portion with at least one opening extending therethough. The method further includes applying fluid pressure to an upstream end of the passage and blocking the fluid pressure by the rupture disk from the passage downstream of the rupture disk. Furthermore, in response to the fluid pressure reaching a predetermined pressure level, causing the rupture disk to rupture. The method also includes catching the ruptured portions of the rupture disk with the catcher to prevent the rupture disk from passing through the at least one opening while simultaneously permitting the fluid to pass through the at least one opening of the catcher.

In certain embodiments, the providing the relief valve further comprises forming the body with a connecting member and an intermediate member, the members coupled together by a first connector, and mounting the rupture disk in the passage at the first connector.

In other certain embodiments, the method also includes reconditioning the relief valve by disconnecting the first connector and removing remaining portions of the rupture disk located at the first connector and installing a new rupture disk at the first connector and re-securing the first connector.

In yet other certain embodiments, providing the relief valve further includes providing the body with an end member that connects to an intermediate member with a second connector, and mounting the catcher in the passage at the second connector.

In still another embodiment, the method includes reconditioning the relief valve by disconnecting the second connector and removing portions of the rupture disk caught by the catcher and re-connecting the second connector.

In a fourth aspect, a method of manufacturing a pressure relief valve assembly is provided, which includes providing a body member having an upstream end adapted to be connected to a source of fluid pressure and a downstream end having a downstream exit. The method also includes forming a passage in the body extending between the upstream end and the downstream end and positioning a rupture disk in the passage to block the fluid pressure of the source from the downstream end, the rupture disk configured to rupture above a predetermined differential fluid pressure. The method also includes forming a catcher having a disk portion with at least one opening therethrough, the catcher opening sized to prevent passage of the rupture disk through the opening. The method further includes positioning the catcher in the passage downstream of the rupture disk such that in response to a rupture disk failure, the catcher prevents passage of any portion of the rupture disk past the catcher while simultaneously allowing fluid flow through the catcher to the downstream exit.

In certain embodiments, the method includes forming the diameter of the passage between the catcher and the rupture disk larger than the diameter of the passage upstream of the rupture disk.

In other certain embodiments, the method includes forming the passage between the catcher and the rupture disk with a smaller bore section having a diameter and a larger bore section having a diameter larger than the diameter of the smaller bore section, wherein the larger bore section is formed proximate to the catcher and the smaller bore section is formed proximate to the rupture disk.

In yet other certain embodiments, wherein forming the at least one opening includes forming a plurality of spaced apart openings on the catcher.

In still another embodiment, forming the at least one opening includes forming the opening to extend substantially across the disk portion of the catcher.

In other certain embodiments, forming the at least one opening includes forming a plurality of openings through the disk portion of the catcher.

In yet other certain embodiments, providing a body member includes providing a connecting member having an upstream end adapted to be connected to the source of fluid pressure, and a downstream end, providing an intermediate member having an upstream end that abuts and is coupleable to the downstream end of the connecting member, and providing an end member having an upstream end wherein the upstream end of the end member secures to a downstream end of the intermediate member.

In another embodiment, positioning the catcher includes positioning the catcher at the upstream end of the end member and the downstream end of the connecting member.

In yet another embodiment, mounting the rupture disk in the passage includes mounting the rupture disk at the downstream end of the intermediate member and the upstream end of the end member.

Other aspects, features, and advantages will become apparent from the following detailed description when taken in conjunction with the accompanying drawings, which are part of this disclosure and which illustrate, by way of example, principles of the inventions disclosed.

### DESCRIPTION OF THE FIGURES

The accompanying drawings facilitate an understanding of the various embodiments.

FIG. 1 is a schematic drawing of a pumping system in which a pressure relief valve assembly is employed to advantage.

FIG. 2 is an enlarged sectional view of the pressure relief valve assembly of FIG. 1.

FIG. 3 is a section view taken along the line 3-3 of FIG. 2 illustrating a rupture disk disposed within the pressure relief valve assembly of FIGS. 1 and 2.

FIG. 4A is a section view taken along the line 4A-4A of FIG. 2 illustrating a catcher disposed within the pressure relief valve assembly of FIGS. 1 and 2.

FIG. 4B is a section view of a second embodiment of the catcher of FIG. 4A.

### DETAILED DESCRIPTION

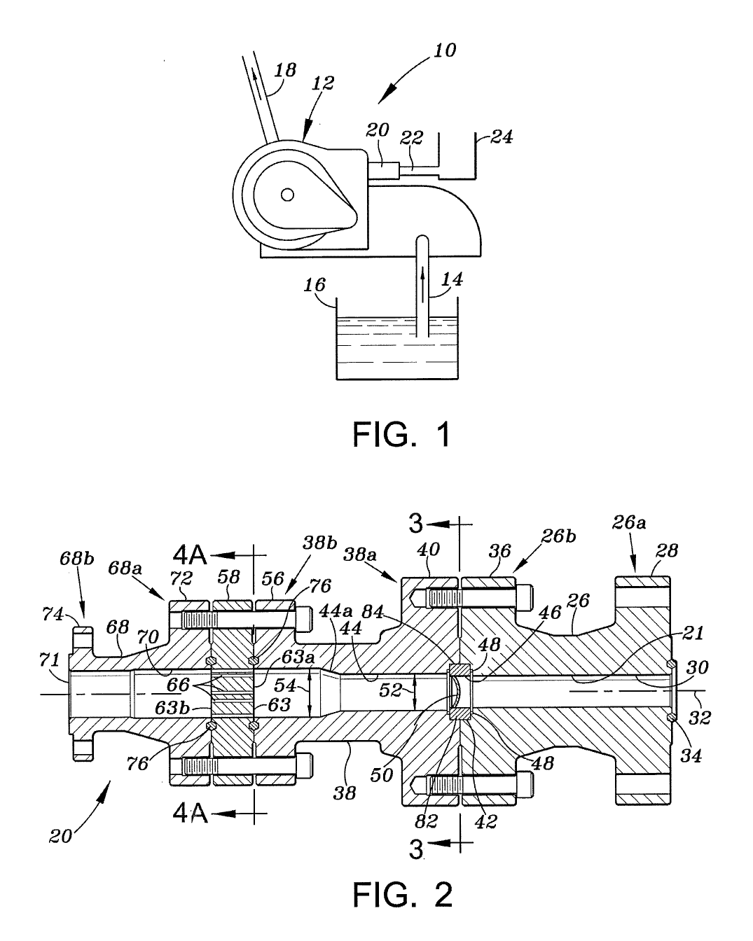

FIGS. 1 and 2 illustrate a pumping system 10 having a pressure relief valve assembly 20 in which a catcher member 58 is employed to capture or otherwise prevent downstream travel of a ruptured portion of a rupture disk 42 within the pressure relief valve assembly 20. In the embodiment illustrated in FIG. 1, a pump assembly 12 is used in connection with a high pressure mud pump; however, the pump assembly 12 is usable in other applications. In operation, the pumping system 10 draws fluid, such as drilling mud, from a holding tank 16 through an intake pipe 14 and discharges the fluid at a substantially higher pressure through a discharge pipe 18. According to embodiments disclosed herein, the discharge pipe 18 is operable to deliver mud to a wellhead assembly for injection into a well.

In the embodiment illustrated in FIG. 1, the pressure relief valve assembly 20 is shown connected directly to the pump assembly 12; however, in the alternative, the pressure relief valve assembly 20 is connectable directly to the discharge pipe 18. In operation, the pressure relief valve assembly 20 prevents an overpressure condition of the pump assembly 12 and the discharge pipe 18. For example, in the event maximum operating pressure in the discharge pipe 18 and/or the pump assembly 12 reaches approximately 30,000 pounds per square inch, the pressure relief valve assembly 20 is operable to prevent a further increase in pressure so as to prevent or otherwise substantially reduce the likelihood of damage to any equipment and/or the well. In FIG. 1, the pressure relief assembly 20 is connected by way of a vent pipe 22 to an open tank 24; however, in alternate embodiments, the vent pipe 22 is configured to discharge directly to the environment. In other alternative embodiments, the vent pipe 22 is omitted, which enables the pressure relief valve assembly 20 to open or vent directly to the environment.

Referring specifically to FIG. 2, the pressure relief valve assembly 20 is generally formed of an upstream tubular/connecting member 26, a central tubular/intermediate member 38, and a downstream/end member 68, each forming a contiguous passage 21 extending through the members 26, 38 and 68, respectively; however, the pressure relief valve assembly 20 is otherwise configurable. For example, pressure relief valve assembly 20 may be formed of a single contiguous body or in the alternative, comprise only connecting member 38 in combination with the intermediate member 38 or the end member 68.

In FIG. 2, the connecting member 26 has an upstream end 26a and a downstream end 26b. A flange 28 is disposed at the upstream end 26a and is configured to interface with and otherwise connect to the pump assembly 12 (FIG. 1). The connecting member 26 is, for example, a standard API type connector suitable for, and rated to, the maximum operating pressure of the discharge pipe 18 and the pump assembly 12. The connecting member 26 comprises a central bore 30 having an axis 32, which forms an upstream portion of the passage 21, and extends between the upstream end 26a and the downstream end 26b. A seal 34 seals the interface between the bore 30 of the connecting member 26 and a fluid source from the pump assembly 12 (FIG. 1), to which the pressure relief valve assembly 20 is fluidly connected. The connecting member 26 has a second flange 36 at the downstream end 26b for coupling to the intermediate member 38.

In FIG. 2, the intermediate member 38 includes a central bore 44 disposed along a central axis that is collinear to the axis 32 forming an intermediate portion of the passage 21. The central bore 44 extends between an upstream end 38a and a downstream end 38b of the central member 38. A flange 40, disposed on the upstream end 38a of the intermediate member 38, is coupled to and otherwise abuts the flange 36 of the connecting member 26. The flanges 36 and 40 are secured together, for example, via a connector that includes a plurality of bolts designed to withstand a predetermined internal pressure rating. In particular, the attachment of the flanges 36 and 40 is preloaded such that the connection can withstand the desired operating pressure without the intermediate member 38 separating from the connecting member 26. In the embodiment illustrated in FIG. 2, the intermediate member 38 has a second flange 56 at the downstream end 38b for coupling to and otherwise securing the end member 68 thereto.

The end member 68 includes a central bore 70 disposed along a central axis that is collinear to the axis 32 forming an end portion of the passage 21. The end member 68 extends between an upstream end 68a that is proximate to the downstream end 38b of the intermediate member 38 and a downstream end 68b, which defines a downstream exit 71. A flange 74 at the downstream end 68b of the end member 68 is coupleable to the vent pipe 22 (FIG. 1).

In the embodiment illustrated in FIG. 2, the rupture disk 42 is disposed in an annular pocket 84 formed in the abutting portions of the respective bores 30, 44 of the connecting member 26 and the intermediate member 38. The rupture disk 42 includes a mounting member 82 having a central bore/opening 46 with a central axis that is collinear to the axis 32. The mounting member 82 is sized to fit and support the rupture disk 42 within the annular pocket 84 and blocks fluid flow through passageway 21. Sealing members 48, such as for example, metal to metal seals, are optionally utilized to fluidly seal the mounting member 82 between both the connecting member 26 and the intermediate member 38.

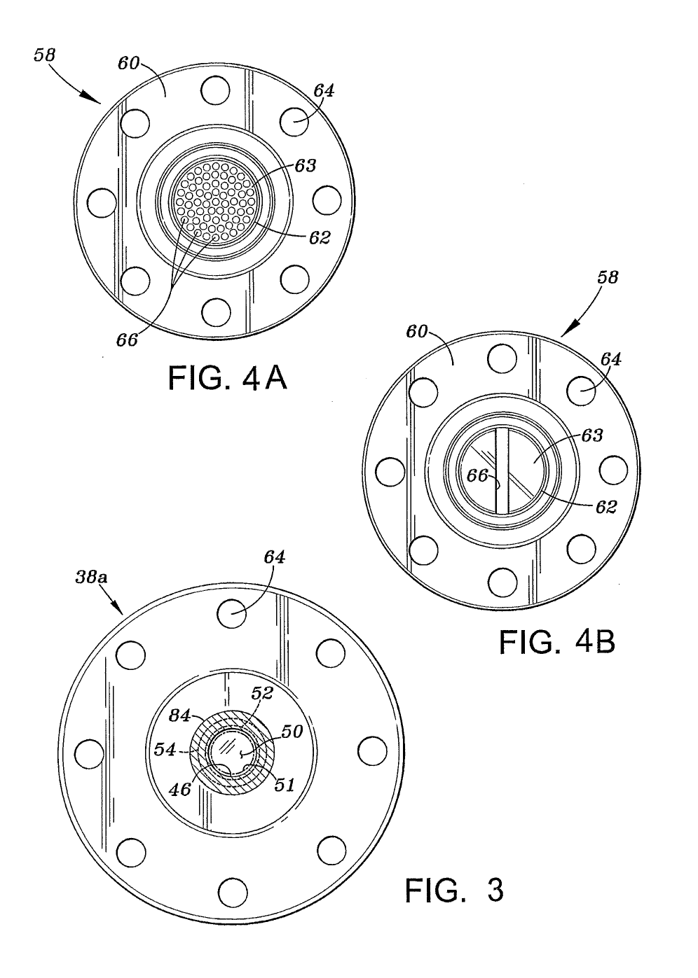

Referring specifically to FIGS. 2 and 3, the rupture disk 42 includes a shearable element 50 secured to the mounting member 82 and disposed within the bore 46. In the embodiment illustrated in FIG. 2, the shearable element 50 is a solid curved plate forming a barrier across bore 46 to block the fluid flow, and thus, the fluid pressure in the bore 30 from the bore 44. The shearable element 50 preferably includes a circumferential groove 51 having a diameter substantially similar to that of the diameter of the bore 30; however, the shearable element 50 can be formed without a groove and further, the diameter of the circumferential groove 51 may be otherwise sized. According to embodiments disclosed herein, the rupture disk 42 is rated to withstand a predetermined differential fluid pressure up to, or slightly less than, the maximum operating pressure of the discharge pipe 18 and/or the pump assembly 12. In operation, the rupture disk 42 is designed to rupture and otherwise shear along the circumferential groove 51 in response to the predetermined differential fluid pressure. The fluid and associated pressure, as explained in further detail below, forces the rupture disk to travel downstream through the passageway 21 until it reaches and is blocked by the catcher 58, which in the embodiment illustrated in FIG. 2, is sandwiched between the intermediate member 38 and the end member 68. Preferably, the rupture disk 42, and in particular, the shearable element 50, is formed of INCONEL® Alloy 600, although the rupture disk 42 may be otherwise formed.

Referring now to FIG. 4A, the catcher 58 includes an outer flange/ring 60 and an inner ring 62. The outer ring 60 is co-axial with the inner ring 62 and both the outer ring 60 and the inner ring 62 have a central axis collinear to the axis 32 (FIG. 2). In the embodiment illustrated in FIG. 4A, the outer ring 60 is a solid plate with passages 64 extending therethrough for connecting and otherwise securing to the flange 56 of the intermediate member 38 and to the flange 72 of the end member 68. The outer diameter of the inner ring 62 is substantially the same as a diameter 54 of the intermediate member 38. Furthermore, the inner ring 62 comprises a disk or plate 63 having at least one opening 66 extending therethrough. In the embodiment illustrated in FIGS. 2 and 4A, the disk or disk portion 63 includes an upstream surface 63a, a downstream surface 63b, wherein the at least one opening 66 extends between the upstream and downstream surfaces 63a and 63b, respectively. Preferably, the catcher member 58 is formed of a one piece section of 4140 steel and machined to the desired configuration such as, but not limited to, the illustrations shown in FIGS. 4A and 4B.

In the embodiment illustrated in FIG. 4A, the at least one opening 66 includes a plurality of spaced apart openings 66 of substantially equal diameter and evenly positioned on the disk 63; however the openings 66 may be otherwise configured. For example, the plurality of openings 66 may have a larger diameter than the diameter illustrated in FIGS. 2 and 4A and may include openings 66 of varying diameters and being non-evenly positioned on the disk 63. Additionally and/or alternatively, the at least one opening 66 can be elongate and extend substantially across the disk 63. For example, in the embodiment illustrated in FIG. 4B, the at least one opening 66 is a generally rectangular slot extending across the diameter of the disk or disk portion 63, although a plurality of slots can be utilized of any width, length or shape (oval, curved, etc.). Regardless of the number and/or shape of the at least one opening 66, the size of the opening(s) 66 is sufficient to enable fluid flow therethough to relieve an overpressure condition, including instances when the disk 63 is at least partially covered by the shearable element. In alternate embodiments, the disk 63 may be substituted by one or more bars extending across or at least substantially across the diameter of the passage 21 or may even be substituted with a screen formed to withstand the high impact forces from the moving shearable element 50 impacting the catcher 58.

Referring back to FIG. 2, the catcher 58 is secured between the flanges 56 and 72 via a connector that includes a plurality of bolts designed to withstand a predetermined internal pressure rating. In particular, the attachment of the flanges 36 and 40 and the catcher 58 is preloaded such that the connection can withstand the desired operating pressure without the intermediate member 38 separating from the end member 68. A pair of sealing members 76 fluidly seal the catcher 58 with both the bore 44 of the intermediate member 26 and the bore 70 of the end member 68.

In FIG. 2, the passageway 21 varies in diameter between the upstream end 26a of the connecting member 26 and the downstream end 68a of the end member 68. For example, in the embodiment illustrated in FIG. 2, the diameter of the bore 30 is less than a diameter of the bore 44 of the intermediate member 38. In particular, the upstream end portion of the bore 44 of the intermediate member 38 has a diameter 52 that is larger than the diameter of the bore 30 of the connecting member 26. Furthermore, the diameter of the bore 44 varies between the upstream end 38a and the downstream end 38b of the intermediate member 38. For example, the bore 44 of the intermediate member increases at a transition zone denoted generally as 44a such that the downstream end of the bore 44 has a diameter 54 upstream of the transition zone 44a that is larger than a diameter 52 of the bore 44 downstream of the transition zone. The diameter 52 is slightly larger than the diameter of the shearable element 50 so as to permit the sheared portion 50 to travel downstream through the passageway 21 while also providing sufficient support for the rupture disk 42 when housed within the relief device 20, which is positioned to counter high fluid pressures. Furthermore, the diameter 54 of the intermediate portion of passageway 21 is larger than the diameter 52 of the passage 21 upstream of the transition zone 44a to enable fluid to continue to flow around the shared portion 50, and thus through the catcher member 58, when the sheared portion 50 is proximate the catcher 58 to thereby prevent pressure increased in system 20 in the event of a rupture. The intermediate member 38 may be otherwise configured such that instead of forming the transition the zone 44a, the diameter of the bore 44 is gradually increased between the upstream end 38a and the downstream end 38b.

During operation, in response to the differential pressure across the shearable element 50 reaching a predetermined pressure level, the shearable element 50 will shear/rupture along its circumferential groove. This allows fluids within the bore 30 to flow through the bore 44 of the intermediate member 38. Because the diameter 52 at the upstream end 38a of the bore 44 and the diameter 54 at the downstream end 38b of the bore 44 are both larger than the diameter of the circumferential groove in the shearable element 50, the sheared/ruptured portion(s) of the shearable element 50 pass through the bore 44 without causing an obstruction therein. The ruptured portion of the shearable element 50 is blocked by the catcher 58 and prevented from further downstream travel through passageway 21 and ultimately exiting the pressure relief valve assembly 20, which can occur at dangerously high velocities. The diameter of the inner ring 62 (FIG. 3) of the catcher 58 is sized and the number and diameter of opening(s) 66 (FIG. 2) are configured to enable fluid in the bore 44 to simultaneously flow around the sheared portion of the shearable element 50, which is contained or otherwise blocked within the bore 44. This configuration prevents subsequent pressure buildups within the pumping system 10 while preventing any portions of the rupture disk from traveling downstream at high velocities through the pressure relief valve assembly 20 causing potential damage to the pressure relief valve assembly 20. Furthermore, the catcher 58 prevents or substantially reduces the likelihood of the shearable element 50 exiting the pressure relief valve assembly at dangerously high velocities, thereby potentially injuring any persons proximate the pump system 10.

After the occurrence of a rupture, the pressure relieve valve assembly 20 is reconditioned by replacing the rupture disk 42 and clearing the ruptured shearable element 50 from within passageway 21 at the catcher 58. In particular, when replacing the rupture disk 42, the flanges 36 and 40 are separated by removing the connecting bolts. The ruptured rupture disk 52 is removed from the annular pocket 84 and replaced with a new rupture disk 52. Once replaced, flanges 46 and 40 are coupled back together. When removing the sheared portions of the shearable element 50, the flanges 56 and 72 are separated by removing the connecting bolts. After the passageway 21 is cleared by removing the shearable element 50, the flanges 56 and 72 are coupled back together.

The pressure relief valve assembly 20 described herein provides distinct advantages when used in connection with the catcher member 58. For example, the catcher member 58 includes a disk 63 that prevents downstream travel of a ruptured portion of a rupture disk 52, which can damage downstream portions of the pressure relieve valve assembly 20 and/or exit the valve assembly 20 at dangerously high velocities and potentially injuring bystanders. Embodiments disclosed herein capture the ruptured portions of the rupture disk 52 within the valve assembly 20 while at the same time preventing overpressure conditions within the pumping system 10. Furthermore, embodiments disclosed herein provide for easy access to the catcher member 58, which enables access to the ruptured portions of the rupture disk 42 for removal from the passageway 21. Furthermore, by forming the passage 21 of varying diameter in the intermediate member 38, the shearable element 50 travels downstream unimpeded until stopped by the catcher member 58. The diameter 54 of intermediate member 38 proximate the catcher member 58 is sized to enable the diameter of the disk member 63 to be large enough to facilitate passage of fluid through the catcher member 58 even when the catcher member 58 stops and is at least partially covered by the shearable element 50. This prevents any additional pressure buildup within the pressure relief valve assembly 20 since fluid is still permitted to flow through the catcher 58.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A pressure relief valve assembly, comprising:
a body having a passage extending therethrough, the body having an upstream end adapted to be connected to a source of fluid pressure, an intermediate portion, and a downstream end having a downstream exit;
a rupture disk mounted in the passage and blocking the fluid pressure of the source from the downstream end, the rupture disk configured to rupture above a predetermined differential fluid pressure; and
a catcher disposed in the passage downstream of the rupture disk, the catcher including a disk portion with at least one opening sized to prevent passage of the rupture disk through the catcher in response to a rupture disk failure while simultaneously allowing fluid flow through the catcher to the downstream exit.

2. The assembly of claim 1, wherein at least a portion of the passage between the catcher and the rupture disk is larger in diameter than the diameter of the passage upstream of the rupture disk.

3. The assembly of claim 1, wherein the passage between the catcher and the rupture disk has a smaller bore section having a diameter and a larger bore section having a diameter larger than the diameter of the smaller bore section, the larger bore section proximate to the catcher and the smaller bore section proximate to the rupture disk.

4. The assembly of claim 1, wherein:
the disk portion includes an upstream surface and a downstream surface; and
the at least one opening extending through the disk portion between the upstream surface and the downstream surface.

5. The assembly of claim 4, wherein the at least one opening comprises a plurality of spaced apart openings.

6. The assembly of claim 4, wherein the at least one opening extends substantially across the disk portion.

7. The assembly of claim 4, wherein the disk portion comprises a diameter substantially equal to the diameter of the body passage in the intermediate portion.

8. The assembly of claim 1, wherein the catcher comprises an outer ring coaxially supporting the disk portion, the outer ring adapted to secure the catcher to the body.

9. The assembly according to claim 1, wherein the rupture disk comprises:
a mounting member having a bore; and
a shearable element disposed within the bore and coupled to the mounting member, the shearable element having a circumferential groove, wherein the shearable element is adapted to detach from the mounting member along the circumferential groove at the predetermined differential fluid pressure.

10. The assembly according to claim 9, wherein a diameter of the circumferential groove is less than a diameter of a portion of the passage between the catcher and the mounting member.

11. The assembly according to claim 1, wherein the body comprises:
a connecting member having a downstream end;
an intermediate member having an upstream end that abuts and is coupleable to the downstream end of the connecting member; and
an annular pocket formed at the abutting portions of the intermediate member and the connecting member for receiving the rupture disk therein, wherein the intermediate member is detachable from connecting member to facilitate access to the annular pocket and rupture disk.

12. The assembly according to claim 1, wherein the body comprises:
an connecting member having an upstream end connected to the source of fluid pressure and a downstream end;
an intermediate member having an upstream end that abuts and is coupleable to the downstream end of the connecting member; and
an end member having an upstream end wherein the upstream end of the end member secures to the downstream end of the intermediate member, the catcher being disposed therebetween.

13. The assembly according to claim 12, wherein:
a connection between the downstream end of the connecting member and the upstream end of the intermediate member have a first internal fluid pressure rating; and
a connection between the downstream end of the intermediate member and the upstream end of the end member having a second and lesser internal fluid pressure rating than the first fluid pressure rating.

14. A catcher for a pressure relieve valve assembly, the pressure relief valve assembly including a body with a passage extending therethrough, the body having an upstream end adapted to be connected to a source of fluid pressure, and a downstream end having a downstream exit, a rupture disk mounted in the passage and blocking the fluid pressure of the source from the downstream end, the rupture disk configured to rupture above a predetermined differential fluid pressure, the catcher comprising:
a disk portion having an upstream surface and a downstream surface, at least one opening extending through the disk portion between the upstream surface and the downstream surface, the disk portion mountable downstream the rupture disk and wherein the at the least one opening is sized to prevent passage of the rupture disk to the downstream exit in response to a rupture disk failure while simultaneously allowing fluid flow through the catcher to the downstream exit.

15. The catcher of claim 14, wherein the at least one opening comprises a plurality of openings.

16. The catcher of claim 14, wherein the at least one opening extends substantially across the disk portion.

17. The catcher of claim 14, wherein the disk portion comprises a diameter substantially equal to the diameter of the body passage.

18. The catcher of claim 14, further comprising an outer ring coaxially supporting the disk portion, the outer ring adapted to secure the catcher to the body.

19. A pressure relief valve assembly, comprising:
a connecting member having an upstream end and a downstream end;
an intermediate member having an upstream end that abuts and connects to the downstream end of the connecting member;
an end member having an upstream end that connects to the downstream end of the intermediate member;
a passage extending from the upstream end of the connection member through the intermediate member and through the downstream end of the end member;
a rupture disk disposed within the passage, the rupture disk configured to block fluid pressure in the portion of the passage in the connecting member from the portion of the passage in the intermediate member, the rupture disk adapted to rupture in response to a predetermined differential fluid pressure; and
a catcher mounted in the passage for blocking portions of the rupture disk to prevent the rupture disk traveling downstream in the event the rupture disk ruptures, the catcher having at least one opening therethrough for enabling fluid to flow into the end member while simultaneously blocking portions of the rupture disk from traveling into the end member.

20. The assembly of claim 19, further comprising external flanges on the downstream end of the connecting member and on the upstream end of the intermediate member for securing the connecting member and the intermediate member together.

21. The assembly of claim 19, further comprising:
flanges on the downstream end of the intermediate member and on the upstream end of the end member; and
wherein the catcher is sandwiched between the flanges on the downstream end of the intermediate member and on the upstream end of the end member.

22. The assembly of claim 19, wherein the rupture disk comprises:
a mounting member having a bore therethrough with a diameter no larger than a diameter of the passage in the intermediate member; and
a shearable element disposed within the bore and coupled to the mounting member, the shearable element having a circumferential groove, the shearable element adapted to shear from the mounting member at the circumferential groove in response to the predetermined differential fluid pressure.

23. The assembly of claim 19, wherein a downstream portion of the passage within the intermediate member has a larger diameter than an upstream portion of the passage within the intermediate member.

24. The assembly of claim 19 wherein the catcher includes a disk portion having an upstream surface and a downstream surface and wherein the at least one opening extends through the disk portion between the upstream surface and the downstream surface.

25. The assembly of claim 24, wherein the at least one opening comprises a plurality of spaced apart openings.

26. The assembly of claim 24, wherein the at least one opening extends substantially across the disk portion.

27. The assembly of claim 19, wherein the catcher comprises an outer ring coaxially supporting a disk portion, the outer ring adapted to secure the catcher between the intermediate member and the end member.

28. A method of relieving pressure, comprising:
providing a relief valve having a body with a passage extending therethrough, a rupture disk mounted in the passage and a catcher mounted in the passage downstream of the rupture disk, the catcher having a disk portion with at least one opening extending therethough;
applying fluid pressure to an upstream end of the passage and blocking the fluid pressure by the rupture disk from the passage downstream of the rupture disk;
in response to an increase in the fluid pressure reaching a predetermined pressure level, causing the rupture disk to rupture; and
catching the ruptured portions of the rupture disk with the catcher to prevent the rupture disk from passing through the at least one opening while simultaneously permitting the fluid to pass through the at least one opening of the catcher.

29. The method according to claim 28, wherein providing the relief valve further comprises forming the body with a connecting member and an intermediate member coupled together by a first connector, and mounting the rupture disk in the passage at the first connector.

30. The method of claim 29 further comprising reconditioning the relief valve by the following steps:
disconnecting the first connector and removing remaining portions of the rupture disk located at the first connector; and
installing a new rupture disk at the first connector and re-securing the first connector.

31. The method of claim 28, wherein providing the relief valve further comprises providing the body with an end member that connects to an intermediate member with a second connector, and mounting the catcher in the passage at the second connector.

32. The method of claim 31 further comprising reconditioning the relief valve by the following steps:
disconnecting the second connector;
removing portions of the rupture disk caught by the catcher; and
re-connecting the second connector.

33. A method of manufacturing a pressure relief valve assembly, comprising:
providing a body member having an upstream end adapted to be connected to a source of fluid pressure, and a downstream end having a downstream exit;
forming a passage in the body extending between the upstream end and the downstream end;
positioning a rupture disk in the passage to block the fluid pressure of the source from the downstream end, the rupture disk configured to rupture above a predetermined differential fluid pressure;
forming a catcher having a disk portion with at least one opening therethrough, the opening sized to prevent passage of the rupture disk through the opening; and
positioning the catcher in the passage downstream of the rupture disk such that in response to a rupture disk failure, the catcher prevents passage of any portion of the rupture disk past the catcher while simultaneously allowing fluid flow through the catcher to the downstream exit.

34. The method of claim 33, further comprising forming the diameter of the passage between the catcher and the rupture disk larger than the diameter of the passage upstream of the rupture disk.

35. The method of claim 33 further comprising forming the passage between the catcher and the rupture disk with a smaller bore section having a diameter and a larger bore section having a diameter larger than the diameter of the smaller bore section, wherein the larger bore section is formed proximate to the catcher and the smaller bore section is formed proximate to the rupture disk.

36. The method of claim 33, wherein forming the at least one opening comprises a forming a plurality of spaced apart openings on the catcher.

37. The method of claim 33, wherein forming the at least one opening comprises forming the opening to extend substantially across the disk portion of the catcher.

38. The method of claim 33, wherein forming the at least one opening comprises forming a plurality of openings through the disk portion of the catcher.

39. The method of claim 33, wherein providing a body member comprises:
providing a connecting member having an upstream end adapted to be connected to the source of fluid pressure, and a downstream end;
providing an intermediate member having an upstream end that abuts and is coupleable to the downstream end of the connecting member; and
providing an end member having an upstream end wherein the upstream end of the end member secures to a downstream end of the intermediate member.

40. The method of claim 39, wherein positioning the catcher comprising positioning the catcher at the upstream end of the end member and the downstream end of the connecting member.

41. The method of claim 39, wherein mounting the rupture disk in the passage comprises mounting the rupture disk at the downstream end of the intermediate member and the upstream end of the end member.
